(19) United States
(12) Patent Application Publication
(10) Pub. No.: US 2024/0088699 A1
(43) Pub. Date: Mar. 14, 2024

(54) CONTROL METHOD FOR ZINC BATTERY AND POWER SUPPLY SYSTEM

(71) Applicant: Energywith Co., Ltd., Tokyo (JP)

(72) Inventors: Takamitsu ONUMA, Tokyo (JP); Masayo HORIKAWA, Tokyo (JP); Shinya MIZUSUGI, Tokyo (JP)

(21) Appl. No.: 18/263,622

(22) PCT Filed: Jan. 25, 2022
(86) PCT No.: PCT/JP2022/002673

§ 371 Date: Jul. 31, 2023

(30) Foreign Application Priority Data
Feb. 2, 2021 (JP) 2021-014855

(51) Int. Cl. H02J 7/00; H01M 10/24; H01M 10/44; H01M 10/46

(52) U.S. Cl. CPC H02J 7/00714; H01M 10/24; H01M 10/44; H01M 10/46; H02J 7/0048

(57) ABSTRACT

In a control method for a zinc battery, when the zinc battery is charged, the charging is terminated when a charging current falls below a first threshold value. Then, even when the charging current does not fall below the first threshold value, the charging is terminated when a charge amount of the zinc battery exceeds a second threshold value. A power supply system comprises a zinc battery and a control unit controlling charging and discharging of the zinc battery. The control unit terminates the charging when a charging current falls below a first threshold value. The control unit terminates the charging when a charge amount of the zinc battery exceeds a second threshold value even when the charging current does not fall below the first threshold value.

### TECHNICAL FIELD

The present disclosure relates to a control method for a zinc battery and a power supply system. This application is based upon and claims the benefit of the priority from Japanese Patent Application No. 2021-014855, filed on Feb. 2, 2021, the entire contents of which are incorporated herein by reference.

### BACKGROUND ART

Patent Literature 1 discloses a method for making a zinc battery stand by in a charged state. In the method described in this literature, a charging step of charging the zinc battery and a discharging step of forcibly discharging the zinc battery are alternately repeated continuously. Patent Literature 2 discloses a method for charging a nonaqueous secondary battery. In the method described in this literature, after charging of the secondary battery is started, the charging is stopped before the capacity charged in the secondary battery reaches the rated capacity of the secondary battery.

### CITATION LIST

### Patent Literature

[Patent Literature 1] Japanese Unexamined Patent Publication No. 2020-182284

[Patent Literature 2] Japanese Unexamined Patent Publication No. 2000-30750

### SUMMARY OF INVENTION

### Problem to be Solved by the Invention

Zinc batteries have attracted attention as secondary batteries used in power supply systems. For example, a nickel-zinc battery is an aqueous battery using an aqueous electrolyte such as an aqueous potassium hydroxide solution, and thus has high safety. In addition, the nickel-zinc battery has a high electromotive force compared with other aqueous batteries due to the combination of a zinc electrode and a nickel electrode. Further, the nickel-zinc battery has an advantage of low cost in addition to superior input/output performance. Zinc batteries may be used, for example, as auxiliary batteries or accessories in electric or hybrid vehicles.

In a power supply system including a secondary battery, after the secondary battery is discharged, a charge amount or a state of charge (SOC) is recovered by charging in preparation for the next discharge. Normally, when such discharge and charge are repeated, the secondary battery gradually degrades, and the discharge capacity decreases.

An object of the present disclosure is to provide a control method for a zinc battery and a power supply system including the zinc battery, which can suppress degradation of the zinc battery and extend a battery life of the zinc battery.

### Solution to Problem

In the control method for a zinc battery according to the present disclosure, when the zinc battery is charged, the charging is terminated when a charging current falls below a first threshold value. Even when the charging current does not fall below the first threshold value, the charging is terminated when the charge amount of the zinc battery exceeds a second threshold value.

A power supply system according to the present disclosure includes a zinc battery and a control unit that controls charging and discharging of the zinc battery. When a charging current falls below a first threshold value, the control unit terminates the charging. Even when the charging current does not fall below the first threshold value, the control unit terminates the charging when the charge amount of the zinc battery exceeds a second threshold value.

When the secondary battery is charged, a charging current value decreases as the SOC approaches 100%. Therefore, the fact that the charging current value falls below a certain threshold value can be used as a criterion for stopping charging. However, according to research by the present inventor, in a case of a zinc battery, even when the SOC greatly exceeds 100%, the charging current value may not sufficiently decrease particularly at the initial stage of operation. In such a case, overcharging of the zinc battery remarkably occurs, and degradation of the zinc battery, that is, a decrease in discharge capacity is promoted by repeating such overcharging. In the above-described control method and the power supply system, even when the charging current does not sufficiently decrease when charging the zinc battery, the charging is terminated when the charge amount of the zinc battery exceeds the second threshold value. As a result, overcharging of the zinc battery can be prevented, degradation of the zinc battery can be suppressed, and the battery life can be extended.

When the zinc battery is charged, the charging current may not fall below the first threshold value and the charge amount may not exceed the second threshold value. Even in such a case, the charging may be terminated when the elapsed time from the start of the charging exceeds a third threshold value. In this case, the charging operation can be terminated more reliably.

The first threshold value may be in the range of 0.01 C to 0.1 C. In this case, the charging operation of the zinc battery can be terminated at an appropriate timing.

The second threshold value may be a value at which the SOC becomes within a range of 90% to 110%. For example, when the second threshold value is a value within such a range, it is possible to appropriately prevent overcharging of the zinc battery and more effectively suppress degradation of the zinc battery.

### Advantageous Effects of Invention

According to the present disclosure, it is possible to provide a control method for a zinc battery and a power supply system that can suppress degradation of the zinc battery and extend the battery life of the zinc battery.

### BRIEF DESCRIPTION OF DRAWINGS

FIG. 1 is a circuit diagram showing an example of the configuration of a power supply system.

FIG. 2 is a diagram illustrating a hardware configuration example of a computer.

FIG. 3 is a flowchart showing a control method for a zinc battery.

FIG. 4 is a diagram conceptually showing conditions for terminating charging.

FIG. 5 is a graph obtained by plotting the relationship between the number of cycles and the discharge capacity retention ratio of a nickel-zinc battery obtained by the cycle test.

FIG. 6 is a graph showing a result of plotting the relationship between the coulombic efficiency and the number of cycles in the cycle test of the nickel-zinc battery.

FIG. 7 is a graph showing an initial charge/discharge curve when the termination of charge is determined only by the charging current and the charging time in the cycle test.

FIG. 8 is a graph showing an initial charge/discharge curve when the termination of charge is determined by a charging current, a charging time, and a charge amount in a cycle test.

FIG. 9 is a graph showing an initial charge/discharge curve when the termination of charge is determined by a charging current, a charging time, and a charge amount in a cycle test.

FIG. 10 is a graph plotting the relationship between the number of cycles and the capacity retention ratio in the cycle test.

### DESCRIPTION OF EMBODIMENTS

Specific examples of the control method for the zinc battery and the power supply system of the present disclosure will be described below with reference to the drawings. In the description of the drawings, the same elements will be denoted by the same reference signs, without redundant description. In the following description, the zinc battery is a concept of a battery using zinc for a negative electrode, such as a nickel-zinc battery, an air-zinc battery, and a silver-zinc battery.

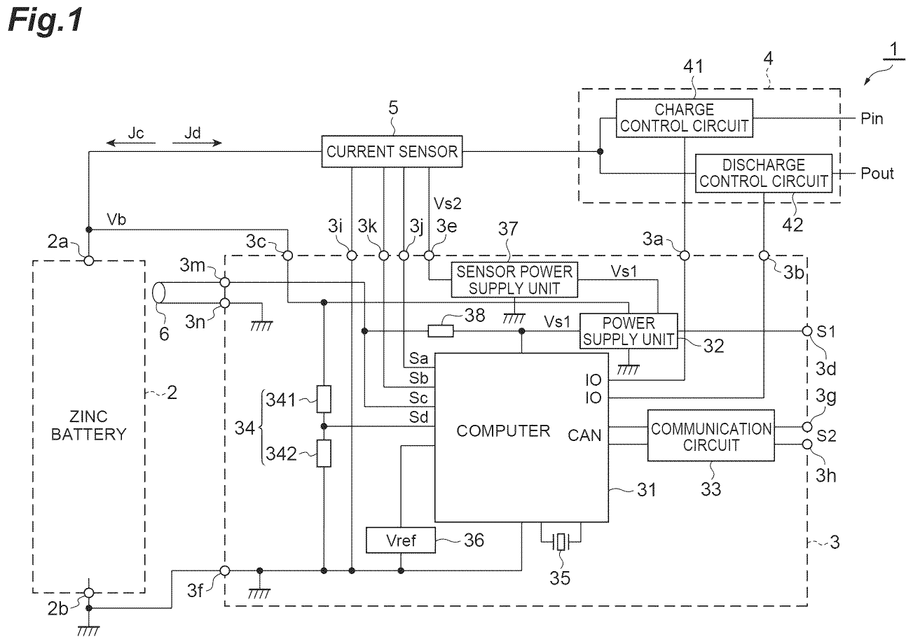

FIG. 1 is a circuit diagram illustrating an example of a configuration of a power supply system 1 according to an embodiment of the present disclosure. The power supply system 1 is used as an auxiliary battery, that is, an accessory of an electric vehicle or a hybrid vehicle, for example. The target to which the power supply system 1 is applied is not limited to a moving vehicle, and the power supply system 1 can also be applied to a fixed object. As an example of an application to the fixed object, the power supply system 1 may be used as an uninterruptible power supply (UPS) in various places such as a home, an office, a factory, and a farm.

As shown in FIG. 1, the power supply system 1 includes a zinc battery 2, a control unit 3, a charge/discharge control circuit 4, a current sensor 5, and a thermistor 6. The zinc battery 2 has a positive terminal 2a and a negative terminal 2b. The zinc battery 2 may include a plurality of cells connected in series between the positive terminal 2a and the negative terminal 2b. The negative terminal 2b is connected to a ground wiring of the power supply system 1.

The charge/discharge control circuit 4 includes a charge control circuit 41 and a discharge control circuit 42. An input terminal of the charge control circuit 41 is electrically connected to an external power supply of the power supply system 1 via a power supply wiring, and receives power supply power Pin from the power supply wiring. The power supply power Pin is, for example, +12V. An output terminal of the charge control circuit 41 is electrically connected to the positive terminal 2a of the zinc battery 2 via the current sensor 5. Upon receiving a charging instruction from the control unit 3, the charge control circuit 41 applies a charging voltage to the positive terminal 2a of the zinc battery 2 and supplies a charging current Jc.

An input terminal of the discharge control circuit 42 is electrically connected to the positive terminal 2a of the zinc battery 2 via the current sensor 5. An output terminal of the discharge control circuit 42 is electrically connected to a power load such as an in-vehicle device outside the power supply system 1. Upon receiving a discharge instruction from the control unit 3, the discharge control circuit 42 receives a discharging current Jd from the positive terminal 2a of the zinc battery 2 and supplies the discharging current Jd to the power load as output power Pout.

In FIG. 1, the current sensor 5 serves as both a current sensor between the charge control circuit 41 and the zinc battery 2 and a current sensor between the discharge control circuit 42 and the zinc battery 2. These current sensors may be provided separately.

The control unit 3 includes a computer 31, a power supply unit 32, a communication circuit 33, a voltage dividing unit 34, an oscillation circuit 35, a reference voltage generation circuit 36, and a sensor power supply unit 37. The control unit 3 is formed by housing these components in one package. The control unit 3 has a plurality of terminals 3a to 3n for signal input and output with the outside of the control unit 3 on the package.

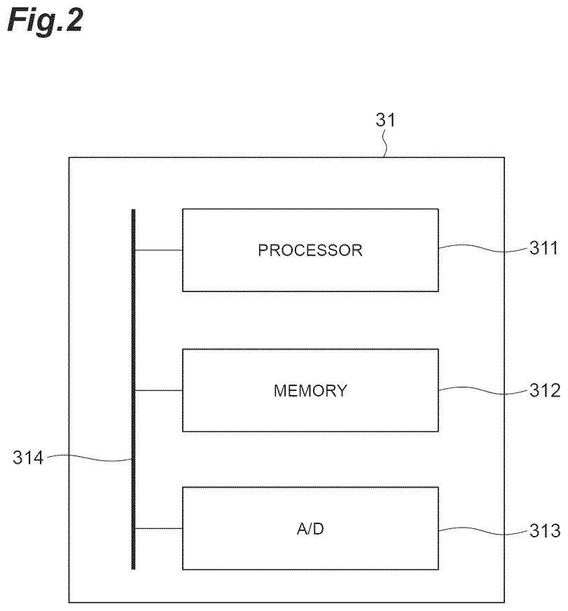

The computer 31 is a computer that controls charging and discharging of the zinc battery 2 and is, for example, a microcomputer. FIG. 2 is a diagram illustrating a hardware configuration example of the computer 31. As shown in this figure, the computer 31 includes a processor 311, a memory 312, and an analog/digital (A/D) conversion circuit 313. The processor 311, the memory 312, and the A/D conversion circuit 313 are connected to each other via a data bus 314. The processor 311 is, for example, a CPU, and the memory 312 is, for example, a flash memory. Each function of the computer 31 is implemented by the processor 311 executing a program stored in the memory 312. For example, the processor 311 performs a predetermined operation on a data read from the memory 312 or a data received via a communication terminal. The processor 311 outputs the calculation result to another device, thereby controlling the other device. Alternatively, the processor 311 stores the received data or calculation result in the memory 312. The computer 31 may be constituted by one computer or may be constituted by a set of a plurality of computers, that is, a distributed system. The hardware configuration of the control unit 3 is not limited to a computer and may be arbitrarily selected as long as it is a circuit having a similar function.

Refer again to FIG. 1. The computer 31 has first and second signal input/output terminals, in other words, I/O ports. The first signal input/output terminal is electrically connected to the control terminal of the charge control circuit 41 via the terminal 3a of the control unit 3. The second signal input/output terminal is electrically connected to the control terminal of the discharge control circuit 42 via the terminal 3b of the control unit 3. The computer 31 controls operations of the charge control circuit 41 and the discharge control circuit 42 by outputting control signals from these signal input/output terminals.

The power supply unit 32 is electrically connected to the positive terminal 2a of the zinc battery 2 via the terminal 3c of the control unit 3. The power supply unit 32 receives the terminal voltage Vb of the zinc battery 2 as a power supply voltage for driving the control unit 3. The power supply unit 32 receives a start signal S1 from the outside of the power supply system 1 via a terminal 3d of the control unit 3. The power supply unit 32 starts voltage conversion according to the state of the start signal S1. The power supply unit 32 supplies a power supply voltage Vs1 converted from the terminal voltage Vb of the zinc battery 2 to the sensor power supply unit 37. The sensor power supply unit 37 generates a constant voltage Vs2 from the power supply voltage Vs1. The sensor power supply unit 37 supplies a constant voltage Vs2 to the current sensor 5 via a terminal 3e of the control unit 3. The power supply unit 32 supplies the power supply voltage Vs1 converted from the terminal voltage Vb of the zinc battery 2 to the power supply terminal of the computer 31, and to the thermistor 6 via the resistor 38. The ground terminal of the computer 31 is electrically connected to the negative terminal 2b of the zinc battery 2 via the terminal 3f of the control unit 3. As a result, the ground terminal of the computer 31 has the same potential as the negative terminal 2b of the zinc battery 2, i.e., the ground potential.

The communication circuit 33 is provided for communication between the computer 31 and the outside of the power supply system 1.

The communication circuit 33 is an interface circuit for serial communication, such as a controller area network (CAN). The communication circuit 33 has differential input/output terminals and differential input/output terminals on the opposite side. One differential input/output terminal of the communication circuit 33 is electrically connected to a communication terminal of the computer 31 via a wiring in the package. The other input/output terminal of the communication circuit 33 is electrically connected to an electronic device outside the power supply system 1 via a pair of terminals 3g and 3h of the control unit 3. The computer 31 transmits and receives a communication signal S2 to and from the outside of the power supply system 1 through the communication circuit 33.

The voltage divider 34 is provided to divide the terminal voltage Vb of the zinc battery 2. The voltage dividing unit 34 includes resistors 341 and 342, which are connected in series to each other. One end of the series circuit including the resistor 341 and 342 is electrically connected to the positive terminal 2a of the zinc battery 2 via the terminal 3c. The other end of the series circuit is electrically connected to the negative terminal 2b of the zinc battery 2 via the terminal 3f of the control unit 3. Therefore, a voltage signal Sd obtained by dividing the terminal voltage Vb in accordance with the resistance ratio of the resistors 341 and 342 is generated at a node between the resistors 341 and 342. The voltage signal Sd is input to an analog input terminal of the computer 31. The voltage signal Sd is converted into a digital signal by the A/D conversion circuit 313 incorporated in the computer 31. The computer 31 can know the magnitude of the terminal voltage Vb based on the magnitude of the voltage signal Sd.

The oscillation circuit 35 is connected to a clock terminal of the computer 31. The oscillator circuit 35 provides a periodic clock signal to the computer 31. The oscillation circuit 35 can be configured by, for example, a quartz crystal resonator.

The reference voltage generation circuit 36 is a reference voltage source IC that generates a reference voltage Vref. The reference voltage Vref generated by the reference voltage generation circuit 36 is input to an analog input terminal of the computer 31 and is converted into a digital signal by the A/D conversion circuit 313 incorporated in the computer 31. The digital signal is used as a reference voltage for analog signals input to the computer 31, that is, the voltage signal Sd described above, voltage signals Sa and Sb and a temperature signal Sc that are described below.

The current sensor 5 detects the magnitudes of the charging current Jc and the discharging current Jd. The current sensor 5 has four terminals. One terminal of the current sensor 5 receives a constant voltage Vs2 from the sensor power supply unit 37 via a terminal 3e of the control unit 3. The other one terminal of the current sensor 5 is connected to the ground potential of the control unit 3 via the terminal 3i of the control unit 3. The remaining two terminals of the current sensor 5 output voltage signals Sa and Sb indicating the magnitude of the charging current Jc and the discharging current Jd, respectively. The voltage signals Sa and Sb are input to the control unit 3 through terminals 3j and 3k of the control unit 3, respectively, and are input to analog input terminals of the computer 31. The voltage signals Sa and Sb are converted into digital signals by the A/D conversion circuit 313 incorporated in the computer 31. The computer 31 can know the magnitude of the charging current Jc or the discharging current Jd based on the difference voltage between the voltage signals Sa and Sb.

The thermistor 6 is provided in the vicinity of the zinc battery 2 to detect a temperature of the zinc battery 2. The thermistor 6 has a pair of terminals, which are connected to terminals 3m and 3n of the control unit 3, respectively. The terminal 3m is connected to an analog input terminal of the computer 31 via a wiring provided inside the package of the control unit 3, and is connected to the power supply unit 32 via the resistor 38 as described above. The terminal 3n is connected to a ground wiring inside the control unit 3. In this configuration, the power supply voltage Vs1 from the power supply unit 32 is divided by the resistance of the thermistor 6 and the resistance 38, and the divided voltage is input to an analog input terminal of the computer 31 as the temperature signal Sc. The resistance value of the thermistor 6 varies depending on the temperature of the zinc battery 2. Therefore, the magnitude of the temperature signal Sc varies according to the temperature of the zinc battery 2. The computer 31 can know the temperature of the zinc battery 2 based on the magnitude of the temperature signal Sc.

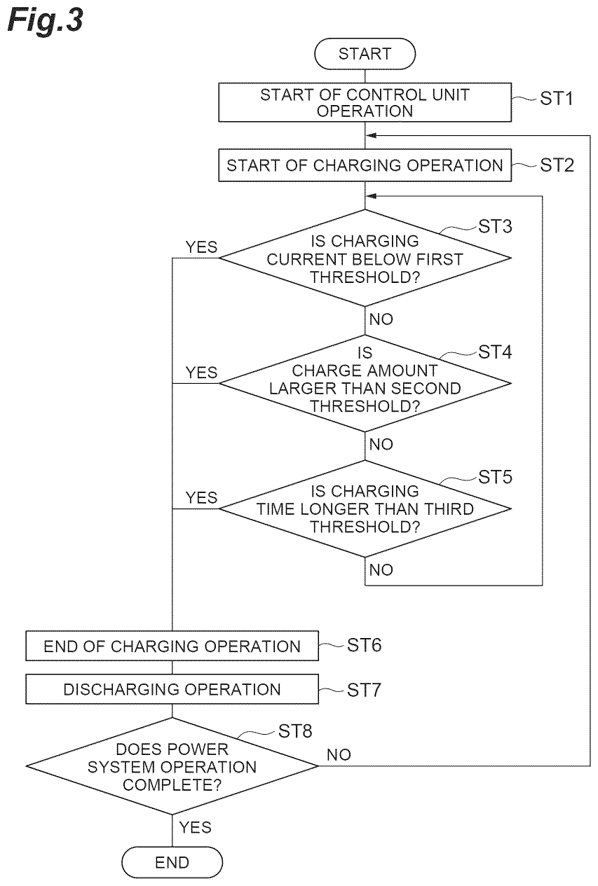

The operation of the power supply system 1 of the present embodiment having the above configuration will be described. At the same time, a control method of the zinc battery according to the present embodiment will be described. FIG. 3 is a flowchart showing a control method of the zinc battery according to the present embodiment.

First, when the power supply unit 32 receives the start signal S1 from the outside of the power supply system 1, the power supply unit 32 starts generating the power supply voltage Vs1. As a result, current detection by the current sensor 5 and temperature detection by the thermistor 6 are enabled. In addition, the computer 31 starts the operation (step ST1). At this time, the computer 31 starts measuring the charge amount of the zinc battery 2. The charge amount is an amount of charge stored in the zinc battery 2. The ratio of the charge amount to the discharge capacity of the zinc battery 2 is referred to as SOC. The charge amount of the zinc battery 2 is obtained by continuously time-integrating the respective current amounts of the charging current Jc and the discharging current Jd obtained based on the magnitudes of the voltage signals Sa and Sb from the current sensor 5, and subtracting the time-integrated value of the discharging current Jd from the time-integrated value of the charging current Jc.

Next, when the computer 31 receives a signal indicating a charging instruction from the outside of the power supply system 1 through the communication circuit 33, the computer 31 transmits a control signal to the charge control circuit 41 to start the charging operation of the charge control circuit 41 (step ST2). For example, the computer 31 first controls the charge control circuit 41 to perform constant-current charging. When the terminal voltage Vb of the zinc battery 2 reaches a predetermined voltage, the computer 31 controls the charge control circuit 41 so as to shift to constant-voltage charging at the predetermined voltage. The current value in the constant current charging is within a range of 0.1 C to 10 C, for example, and is 0.3 C in one example. In the present specification, a magnitude of a current that completely discharges a theoretical capacity of a battery in one hour is defined as 1 C. The voltage value in the constant voltage charging is, for example, within a range of 1.75V to 1.95V, and is 1.9V in one embodiment.

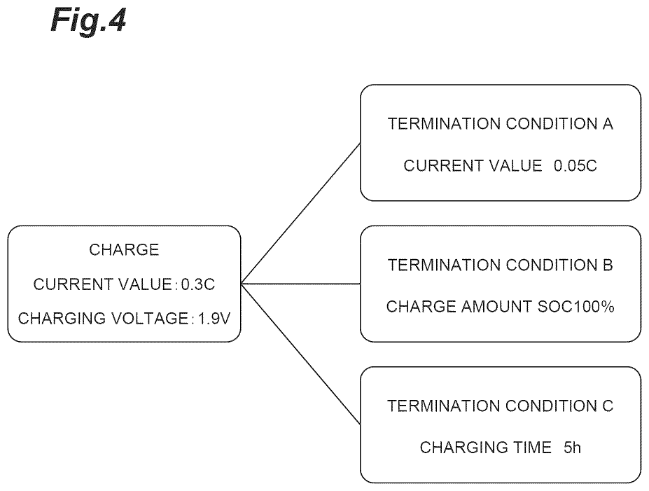

When the charging operation is started, the computer 31 repeatedly determines whether or not the charging should be terminated. FIG. 4 is a diagram conceptually showing conditions for terminating charging. First, based on the magnitudes of the voltage signals Sa and Sb from the current sensor 5, the computer 31 determines whether or not the current amount of the charging current Jc falls below a first threshold value (step ST3). This condition is shown as termination condition A in FIG. 4. When the charging voltage is constant, the magnitude of the charging current Jc flowing through the zinc battery 2 gradually decreases as the charge amount increases, in other words, as the SOC approaches 100%. Therefore, the magnitude of the charging current Jc has a close correlation with the charge amount of the zinc battery 2. The first threshold value is, for example, within a range of 0.01 C to 0.1 C, and is 0.05 C in one example. When the current amount of the charging current Jc is less than the first threshold value (step ST3: YES), the computer 31 terminates the charging operation of the charge control circuit 41 (step ST6). When the current amount of the charging current Jc is not less than the first threshold value (step ST3: NO), the computer 31 determines whether the charge amount of the zinc battery 2 exceeds a second threshold value (step ST4). This condition is shown as termination condition B in FIG. 4. The second threshold value is a value at which the SOC becomes within a range of, for example, 90% to 110%, preferably 90% to 100%. In one embodiment, the second threshold is a value at which the SOC is 100%. When the charge amount of the zinc battery 2 exceeds the second threshold value (step ST4: YES), the computer 31 terminates the charging operation of the charge control circuit 41 (step ST6). When the charge amount of the zinc battery 2 does not exceed the second threshold value (step ST4: NO), the computer 31 determines whether an elapsed time from the start of the charging operation of the charge control circuit 41 exceeds a third threshold value (step ST5). This condition is shown as termination condition C in FIG. 4. The third threshold value is, for example, within a range of 1 hour to 20 hours, and is 5 hours in one example. The third threshold value is set according to the magnitude of the charging current Jc. When the elapsed time exceeds the third threshold value (step ST5: YES), the computer 31 terminates the charging operation of the charge control circuit 41 (step ST6). When the elapsed time does not exceed the third threshold value (step ST5: NO), the computer 31 continues the charging operation of the charge control circuit 41. Thereafter, steps ST3 to ST5 are repeatedly performed until the charging operation of the charge control circuit 41 is completed in step ST6.

After step ST6, when the computer 31 receives a signal indicating a discharge instruction from the outside of the power supply system 1 through the communication circuit 33, the computer 31 transmits a control signal to the discharge control circuit 42 and causes the discharge control circuit 42 to perform a discharge operation (step ST7). Thereafter, steps ST2 to ST7 described above are repeatedly performed until the operation of the power supply system 1 is terminated (step ST8).

Effects obtained by the power supply system 1 and the control method for the zinc battery 2 of the present embodiment having the above-described configuration will be described. In the present embodiment, when the current amount of the charging current Jc falls below the first threshold value in charging the zinc battery 2, the charging is terminated. Even when the current amount of the charging current Jc does not fall below the first threshold value, the charging is terminated when the charge amount of the zinc battery 2 exceeds the second threshold value. In general, when a secondary battery such as the zinc battery 2 is charged, the charging current value gradually decreases as the SOC approaches 100%. Therefore, the fact that the charging current value falls below a certain threshold value can be used as a criterion for stopping charging. However, according to research by the present inventor, in the case of a zinc battery, even when the SOC greatly exceeds 100%, the charging current value may not sufficiently decrease particularly at the initial stage of operation. In such a case, overcharging of the zinc battery 2 remarkably occurs, and degradation of the zinc battery 2, that is, a decrease in discharge capacity is promoted by repeating such overcharging. In the present embodiment, even when the charging current does not sufficiently decrease when charging the zinc battery 2, the charging is terminated when the charge amount of the zinc battery 2 exceeds a predetermined second threshold value. As a result, overcharging of the zinc battery 2 can be prevented, degradation of the zinc battery 2 can be suppressed, and the battery life can be extended.

When charging the zinc battery 2, there is a case where the charging current Jc does not fall below the first threshold value and the charge amount does not exceed the second threshold value. Even in such a case, the charging may be terminated when the elapsed time from the start of the charging exceeds the third threshold value as in the present embodiment. In this case, the charging operation can be terminated more reliably.

As in the present embodiment, the first threshold value may be within a range of 0.01 C to 0.1 C. In this case, the charging operation of the zinc battery 2 can be terminated at an appropriate timing.

As in the present embodiment, the second threshold value may be a value at which the SOC becomes within a range of 90% to 110%. For example, when the second threshold value is a value within such a range, it is possible to appropriately prevent overcharging of the zinc battery 2 and more effectively suppress degradation of the zinc battery 2. The second threshold value may be a value at which the SOC becomes within a range of 90% to 100%. Alternatively, as shown in the following examples, the second threshold value may be a value at which the SOC becomes greater than 100% and equal to or less than 110%. Even in this case, degradation of the zinc battery 2 can be suppressed.

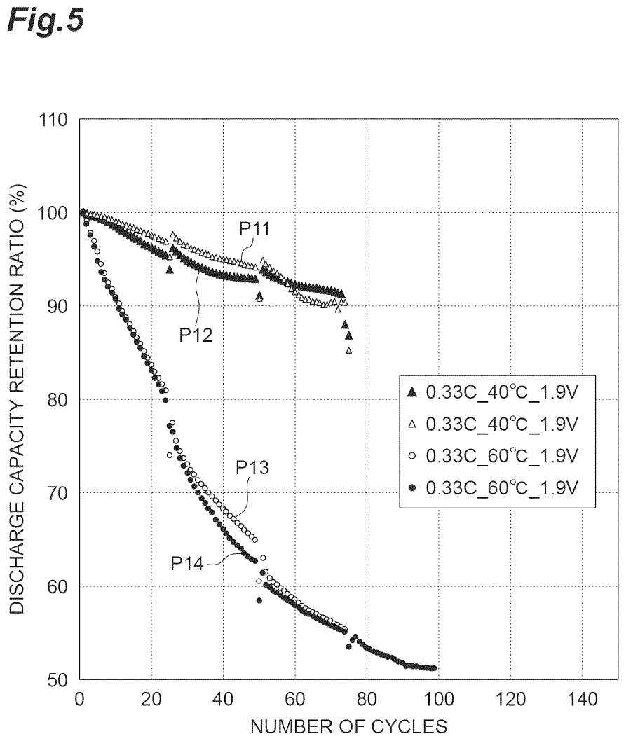

Here, the effect of the present embodiment described above will be described in more detail. FIG. 5 is a graph plotting the relationship between the number of cycles and the discharge capacity retention ratio (%) of the nickel-zinc battery obtained by the cycle test. The discharge capacity retention ratio is a ratio of the discharge capacity at each time point to the initial discharge capacity. In FIG. 5, plots P11 and P12 are graphs relating to two nickel-zinc batteries at a battery temperature of 40° C., respectively. Plots P13 and P14 are graphs relating to two nickel-zinc batteries at a battery temperature of 60° C., respectively. In this cycle test, the current value during the constant current charging period was set to 0.33 C, and the voltage value during the constant voltage charging period was set to 1.9V. In FIG. 5, the vertical axis represents the discharge capacity retention ratio, and the horizontal axis represents the number of cycles. Referring to FIG. 5, it can be seen that the discharge capacity retention ratio decreases as the number of cycles increases at any battery temperature. A decrease in the discharge capacity retention ratio means degradation of the nickel-zinc battery. Referring to FIG. 5, it can be seen that as the battery temperature increases, the decrease in the discharge capacity retention ratio, that is, the degradation of the zinc battery proceeds faster.

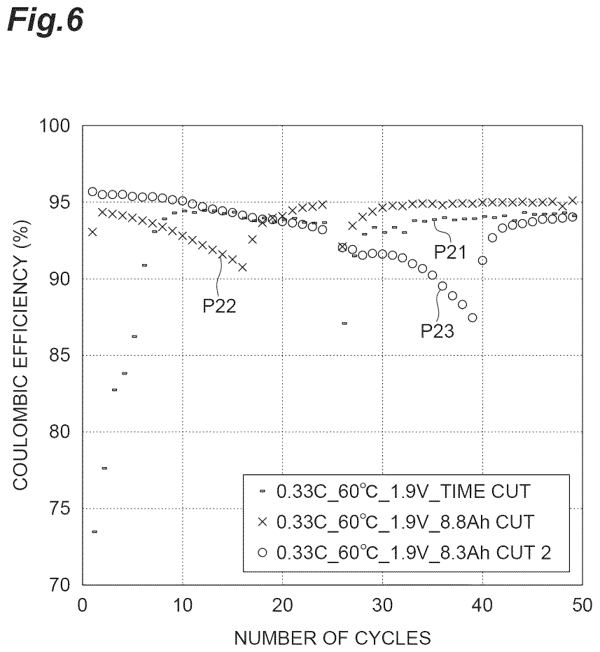

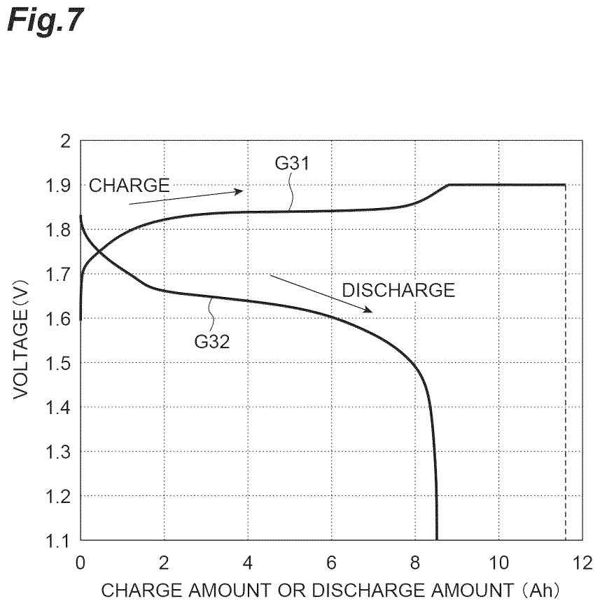

The inventor has studied the cause of the degradation of the nickel-zinc battery advancing faster as the battery temperature increases, and the solution thereof. FIG. 6 shows the result of plotting the relationship between the coulombic efficiency and the number of cycles in the cycle test of the nickel-zinc battery. The coulombic efficiency is a value obtained by expressing the ratio of the discharge capacity at the time of discharge to the charge capacity at the time of charge in percentage. That is, the coulombic efficiency represents the degree of overcharge of the nickel-zinc battery, and a smaller coulombic efficiency means a larger degree of overcharge. In this cycle test, the battery temperature was 60° C., the charging current during the constant current charging period was 0.33 C, the charging voltage during the constant voltage charging period was 1.9V, the discharging current was 0.3 C, and the threshold voltage for determining the termination of discharging was 1.1V. In each of the three nickel-zinc batteries, the termination conditions of the charging operation were different from each other. In FIG. 6, plot P21 shows the coulombic efficiencies of nickel-zinc batteries set to terminate charging only by termination conditions A and C of FIG. 4. However, the first threshold value of the charging current under the termination condition A is 0.05 C, and the third threshold value of the charging time under the termination condition C is 5 hours. Plots P22 and P23 show the coulombic efficiencies of nickel-zinc batteries set to terminate charging according to termination conditions A, B and C of FIG. 4. The plot P22 shows a case where the second threshold value of the charge amount of the termination condition B is set to 8.8 Ah. The charge amount of the 8.8 Ah is 110% in terms of SOC. The plot P23 shows a case where the second threshold value of the charge amount of the termination condition B is set to 8.3 Ah. The charge amount of the 8.3 Ah is 100% in terms of SOC. In the plots P22 and 23, the first threshold value under the termination condition A and the third threshold value under the termination condition C are the same as those in the plot P21. Referring to the plot P21 of FIG. 6, it can be seen that in the case where the termination of charging is determined based on only the charging current and the charging time, the coulombic efficiency significantly decreases particularly in the initial cycle, that is, in the period from the first cycle to the eighth cycle. FIG. 7 is a graph showing the charge/discharge curve of the first time, that is, the first cycle corresponding to the plot P21. In FIG. 7, a curve G31 represents a charging curve, and a curve G32 represents a discharging curve. The vertical axis represents terminal voltage (V) of the nickel-zinc battery, and the horizontal axis represents charge amount or discharge amount (Ah). Referring to the charging curve G31 in FIG. 7, it can be seen that the terminal voltage gradually increases as the charge amount increases. Then, even after the terminal voltage reaches a predetermined terminal voltage (1.9V in this case), charging continues, and the charge amount finally reaches near 12 Ah. On the other hand, referring to the discharge curve G32 in FIG. 7, it can be seen that the terminal voltage gradually decreases as the discharge amount increases. The discharge amount finally reaches only near 8.3 Ah. From this result, it is understood that the charging current does not sufficiently decrease in the initial stage of the cycle, and the overcharge progresses while the termination condition A is not satisfied. When the temperature of the nickel-zinc battery increases, a decomposition voltage of an electrolyte decreases. As a result, the charging reaction and the decomposition reaction of the electrolyte occur concertedly, and the current value does not converge even when the voltage is reached to the charging voltage. This is considered to be the reason why the charging current does not decrease sufficiently.

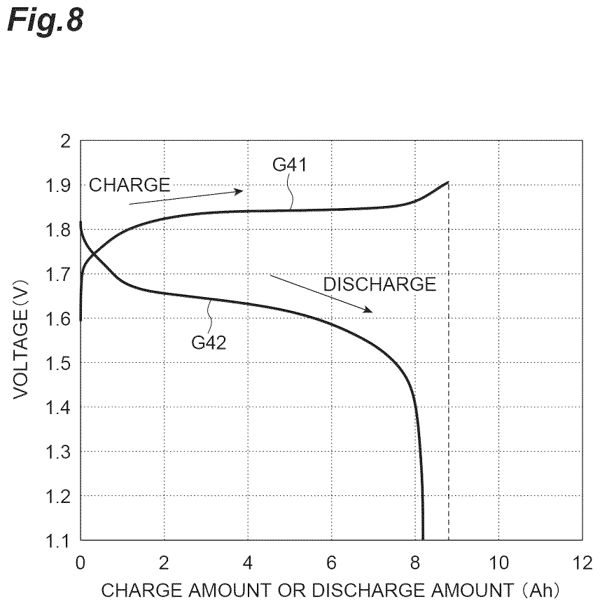

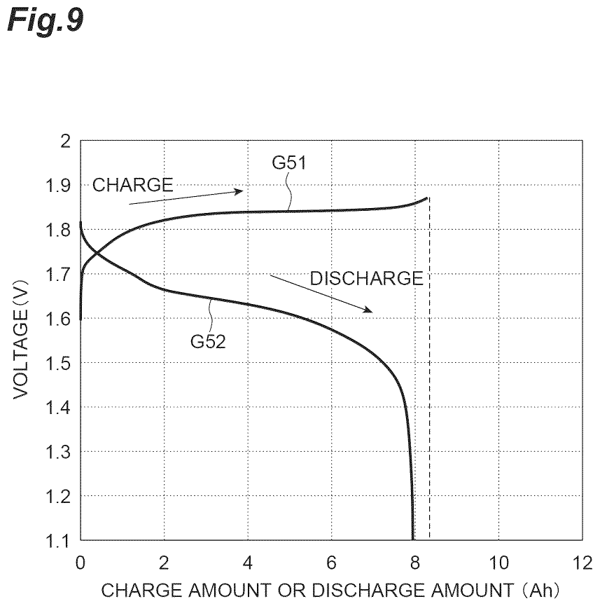

On the other hand, referring to the plots P22 and P23 in FIG. 6, it can be seen that, when the termination of charging is determined based on the charge amount in addition to the charging current and the charging time, the decrease in the coulombic efficiency is reduced over the entire cycle including the initial stage of the cycle. FIG. 8 is a graph showing an initial charge/discharge curve corresponding to the plot P22. FIG. 9 is a graph showing an initial charge/discharge curve corresponding to the plot P23. In FIGS. 8 and 9, curves G41 and G51 represent charging curves, and curves G42 and G52 represent discharging curves. The vertical axis represents the terminal voltage (V) of the nickel-zinc battery. The horizontal axis represents the charge amount or the discharge amount (Ah). Referring to the charging curve G41 in FIG. 8, charging is terminated when the charge amount reaches 8.8 Ah. 8.8 Ah is the second threshold value in this test. On the other hand, referring to the discharge curve G42, the discharge amount finally reaches near 8.1 Ah, so it can be seen that the coulombic efficiency is improved compared to FIG. 7. Similarly, referring to the charging curve G51 in FIG. 9, the charging is terminated when the charge amount reaches 8.3 Ah. 8.3 Ah is the second threshold value in this test. On the other hand, referring to the discharge curve G52, the discharge amount finally reaches near 8.0 Ah, so it can be seen that the coulombic efficiency is further improved compared to FIG. 8.

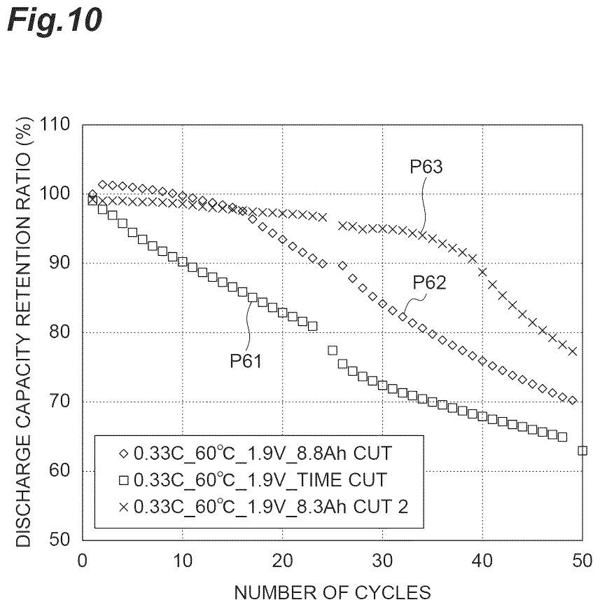

In this manner, by determining the termination of charging using the charge amount, it is possible to suppress overcharging at the initial stage of the cycle. FIG. 10 is a graph plotting the relationship between the number of cycles and the discharge capacity retention ratio in the above cycle test. Plot P61 corresponds to plot P21 of FIG. 6. Plot P62 corresponds to plot P22 of FIG. 6. Plot P63 corresponds to plot P23 of FIG. 6. Referring to FIG. 10, it can be seen that the degree of decrease in the discharge capacity retention ratio is smaller, in other words, the degradation of the nickel-zinc battery is suppressed, in the case where the termination of charging is determined based on the plots P21 and P23, i.e., the charging current and charging time in addition to the charge amount, than in the case where the termination of charging is determined based on only the plot P22, i.e., the charging current and charging time. In addition, comparing the plot P22 and the plot P23, it can be seen that the smaller the second threshold value of the charge amount is, the smaller the degree of decrease in the discharge capacity retention ratio is, in other words, the degradation of the nickel-zinc battery is suppressed.

The control method for a zinc battery and the power supply system according to the present invention are not limited to the examples of the above-described embodiments, but is defined by the scope of claims and intended to include all modifications within the meaning and scope equivalent to the scope of claims.

In the above-described embodiment, regardless of the temperature of the zinc battery 2, the charging is terminated when the charge amount of the zinc battery 2 exceeds the second threshold value. The termination of charging when the charge amount of the zinc battery 2 exceeds the second threshold value may be performed only when the temperature of the zinc battery 2 exceeds a predetermined threshold value. As shown in FIG. 5, this is because the problem to be solved by the above-described embodiment is more significant when the temperature of the zinc battery is high. In this case, the computer 31 of the control unit 3 can know the temperature of the zinc battery 2 based on the temperature signal Sc from the thermistor 6.

### REFERENCE SIGNS LIST

1: power supply system, 2: zinc battery, 2a: positive terminal, 2b negative terminal, 3: control unit, 3a to 3n: terminal, 4: charge/discharge control circuit, 5: current sensor, 6: thermistor, 31: computer, 32: power supply unit, 33: communication circuit, 34: voltage dividing unit, 35: oscillation circuit, 36: reference voltage generation circuit, 37: sensor power supply unit, 38: resistor, 41: charge control circuit, 42: discharge control circuit, 311: processor, 312: memory, 341,342: resistor, Jc: charging current, Jd: discharging current, Pin: power supply power, Pout: output power, S1: start signal, S2: communication signal, Sa and Sb: voltage signal, Sc: temperature signal, Sd: voltage signal, Vb: terminal voltage, Vref: reference voltage, Vs1: power supply voltage, Vs2: constant voltage.

1. A control method for zinc battery, comprising:
terminating charging the zinc battery when a charging current falls below a first threshold value in the charging the zinc battery; and
terminating charging the zinc battery when a charge amount of the zinc battery exceeds a second threshold value even when the charging current does not fall below the first threshold value.

2. The control method for zinc battery according to claim 1, further comprising:
terminating charging the zinc battery when an elapsed time from a start of the charging exceeds a third threshold value even when the charging current does not fall below the first threshold value and when the charge amount of the zinc battery does not exceed the second threshold value.

3. The control method for zinc battery according to claim 1, wherein the first threshold value is in a range of 0.01 C to 0.1 C.

4. The control method for zinc battery according to claim 1, wherein the second threshold value is a value at which an SOC becomes within a range of 90% to 110%.

5. A power supply system, comprising:
a zinc battery; and
a control unit configured to control charging and discharging of the zinc battery,
wherein the control unit terminates the charging when a charging current falls below a first threshold value and terminates the charging when a charge amount of the zinc battery exceeds a second threshold value even when the charging current does not fall below the first threshold value.
